(19) United States
(12) Patent Application Publication
(10) Pub. No.: US 2014/0116062 A1
(43) Pub. Date: May 1, 2014

(54) METHOD AND SYSTEM FOR COMBUSTING BOIL-OFF GAS AND GENERATING ELECTRICITY AT AN OFFSHORE LNG MARINE TERMINAL

(71) Applicant: CHEVRON U.S.A. INC., San Ramon, CA (US)

(72) Inventor: John Surjono Hartono, San Ramon, CA (US)

(73) Assignee: CHEVRON U.S.A. INC., San Ramon, CA (US)

(21) Appl. No.: 14/003,764

(22) PCT Filed: Jul. 19, 2012
(86) PCT No.: PCT/US12/47297

§ 371 Date: Oct. 18, 2013

Related U.S. Application Data
(60) Provisional application No. 61/509,503, filed on Jul. 19, 2011.
(60) Provisional application No. 61/509,507, filed on Jul. 19, 2011.

(51) Int. Cl. F02C 3/22; F17C 13/08; F17C 9/02

(52) U.S. Cl. CPC F02C 3/22; F17C 9/02; F17C 13/082
USPC 60/772; 62/48.1; 60/39.465

(57) ABSTRACT

A system for combusting boil-off gas and generating electricity at an offshore LNG marine terminal distant from an onshore LNG facility is disclosed. BOG produced as a result of LNG transfer between an onshore LNG facility and an LNG carrier, is combusted to produce power which drives an electrical generator producing electricity. None or a reduced amount of BOG needs to be returned to an onshore LNG facility, as some of the BOG is combusted at the offshore marine terminal.

### FIELD OF THE INVENTION

The present invention relates to the combustion of Boil-Off Gas (BOG) and generation of electricity at Liquefied Natural Gas (LNG) facilities.

### BACKGROUND OF THE INVENTION

Many LNG onshore facilities are located adjacent shallow coastal bodies of water, such as LNG liquefaction plants and LNG regasification plants. LNG is transferred to and from LNG carriers located offshore, respectively, relative to the LNG facilities. Often the depth of the water does not reach depths sufficient to allow large LNG carriers to navigate within close proximity of LNG storage tanks of the onshore LNG facilities. Modern LNG carriers often require a minimum 12.5 meters of draft. This required draft may not be available within 10-20 kilometers of LNG storage tanks in many cases.

According, it has been proposed that jetties be built that are 15-20 kilometers in length. LNG pipelines will extend from the LNG storage tanks along the jetties. Alternatively, subsea pipelines may be used to reach an offshore marine terminal where the LNG carrier is moored. Because of this long distance, significant pressure is needed to move the LNG between the storage tanks and the offshore marine terminal where the LNG carrier is loaded or unloaded of LNG cargo.

A significant amount of boil-off gas (BOG) is generated when the pressurized LNG is discharged into LNG storage tanks, particularly on board an LNG carrier. Typically, the LNG storage tanks are maintained slightly above atmospheric pressure. The generated boil-off gas (BOG) on LNG carriers is often returned to the onshore LNG storage tanks. When there is too much BOG generated, the current practice is to flare this gas. This flaring is environmentally banned in many countries, except in emergency situations. Also, flaring represents a loss of energy with little economic return. Sending the BOG back to shore requires large compressors to pressurize and move the BOG to shore. The power requirements of the compressors are large—perhaps as much as 15 Mega Watts or more.

There is a need for a method and system that handles BOG in a more economical manner.

### SUMMARY OF THE INVENTION

A system for combusting boil-off gas and generating electricity at an offshore LNG marine terminal is disclosed. The system comprises an onshore LNG facility, an offshore LNG marine terminal and a fluid transfer system conducting fluids between the onshore LNG facility and the offshore LNG marine terminal. The onshore LNG facility includes at least one LNG storage tank storing LNG. The onshore LNG facility may be an LNG liquefaction plant or a LNG regasification plant.

The offshore marine terminal comprises:
i.) a platform anchored relative to a sea floor;
ii.) a BOG storage tank for storing BOG and supported by the platform;
iii.) a combustor, in fluid communication with the offshore BOG storage tank to receive BOG there from and for combusting BOG; and
iv.) an electrical generator for generating electricity which is powered by the combustor.

The transfer conduit system comprises:
i) a main LNG transfer conduit transferring LNG between the onshore LNG facility and the offshore marine LNG terminal;
ii) an auxiliary LNG transfer conduit transferring LNG between the onshore LNG facility and the offshore marine LNG terminal; and
iii) a main BOG transfer conduit for transferring BOG between the onshore LNG facility and the offshore marine LNG terminal.

The offshore marine terminal of claim 1 is at least two kilometers from an onshore LNG facility in one embodiment, at least ten kilometers in another embodiment, and even at least twenty kilometers in yet another embodiment.

The offshore marine terminal further comprises at least one electrical conduit for transferring electricity. Also, the offshore marine terminal may also include a BOG conduit adapted for receiving BOG from an LNG carrier and transferring the BOG to the BOG storage tank. A booster gas compressor may be included in the offshore marine terminal which blows BOG through a BOG transfer conduit. The offshore marine terminal may also include a vaporizer to vaporize LNG, the vaporizer being in fluid communication with the offshore BOG storage tank to supply BOG to the BOG storage tank.

A heater for heating BOG may be included in the offshore marine terminal. The heater is in fluid communication with the combustor to provide heated BOG to the combustor.

The offshore marine terminal of claim 1 may further include a loading arm adapted for transferring LNG between an LNG carrier and the offshore marine terminal.

The combustor and electrical generator may be are a combined gas turbine generator. Alternatively, the combustor may be a diesel engine which combust BOG.

The platform may take several forms such as a jetty extending to onshore, a fixed platform supported upon legs anchored to the sea floor, or a floating platform anchored relative to the sea floor.

Electricity generated at the offshore marine terminal may be transmitted to an LNG carrier so that combustors on the LNG carrier may be shut off during LNG loading and unloading to reduce emissions from the LNG carrier.

It is an object to more productively use BOG created during LNG transmission between an offshore LNG carrier and an onshore LNG facility while minimizing the transport of the BOG.

Another object is to apply “cold ironing” to a berthed LNG carrier and reduce subsequent emissions of pollutants, such as nitrous oxide (NOX), sulfur dioxide (SOX) and carbon dioxide (CO₂), during mooring of the LNG carrier at an offshore marine terminal while the LNG carrier is being loaded with or unloaded of LNG by utilizing BOG to generate electricity at the offshore marine terminal and transferring at least a portion of the generated electricity to the LNG carrier.

A method for combusting BOG and generating electricity at an offshore marine terminal is disclosed. BOG is received and stored in an offshore BOG storage tank of an offshore marine terminal. BOG received from the offshore BOG storage tank is combusted and electricity is generated at the offshore marine terminal. The electricity is then transmitted for use.

The electricity may be transmitted to one or more locations. In one embodiment, the electricity is transmitted to an onshore facility from the offshore marine terminal. In another embodiment, the electricity is transmitted to at least one of a pump or compressor of the offshore marine terminal. Alternatively, the electricity is transmitted to an LNG carrier. At least one combustor and at least one generator on the LNG carrier may be shut down to reduce emissions while LNG is being loaded on or off the LNG carrier. The generated electricity may also be used to power at least one gas compressor to blow BOG back to the onshore LNG facility.

At least a portion of the received BOG may be collected from at least one storage tank on an LNG carrier. Alternatively, at least a portion of the received BOG may be received from an onshore LNG facility. Furthermore, at least a portion of the received BOG can be generated using an LNG vaporizer of the offshore marine terminal.

Also, a method is disclosed for utilizing offshore boil-off gas (BOG) stored in an offshore BOG storage tank, the method comprising:
capturing BOG from at least one of an LNG carrier and an LNG conduit transferring LNG from an onshore LNG facility; and
storing the captured BOG in a gas storage tank disposed on an offshore marine terminal;
transferring boil-off gas from the offshore storage tank to an offshore combustor and electrical generator to combust the BOG and generate electricity; and
transferring the electricity generated by the offshore electrical generator to an onshore power grid.

### BRIEF DESCRIPTION OF THE DRAWINGS

These and other objects, features and advantages of the present invention will become better understood with regard to the following description, pending claims and accompanying drawings where:

FIG. 1 is a schematic drawing of a system including an offshore marine terminal which is adapted to load LNG from an onshore LNG facility on to an LNG carrier berthed at the terminal wherein the offshore marine terminal also has the capability of combusting BOG and generating electricity;

FIG. 2 is a schematic drawing of a system including an offshore marine terminal wherein LNG from an LNG carrier berthed at the terminal is unloaded and transferred to an onshore LNG facility and the offshore marine terminal also has the capability of combusting BOG and generating electricity; and

FIG. 3 is a schematic drawing of a system including an offshore marine terminal which is idle, i.e. no LNG is being transferred relative to an LNG carrier, wherein electricity is generated by combusting BOG received from an LNG storage tank of the offshore marine terminal wherein BOG is partially produced by vaporizing LNG from an onshore LNG facility and/or BOG is received from the onshore LNG facility.

### DETAILED DESCRIPTION

A system 20 is shown for combusting BOG at an offshore marine terminal 22. The combusted BOG gas is used to power equipment to generate electricity. An LNG carrier 24 is berthed at marine terminal 22. Marine terminal 22 is generally located distant from an onshore LNG facility 26. For example, offshore marine terminal 22 could be greater than 2 kilometers, or greater than 10 kilometers or even greater than 20 kilometers from the onshore LNG facility 26. The LNG facility 26 could be a liquefaction plant where natural gas is converted to LNG. Alternatively, the LNG facility could be a regasification plant which receives and stores LNG and then regasifies the LNG for input to a natural gas pipeline network designed to redistribute the natural gas.

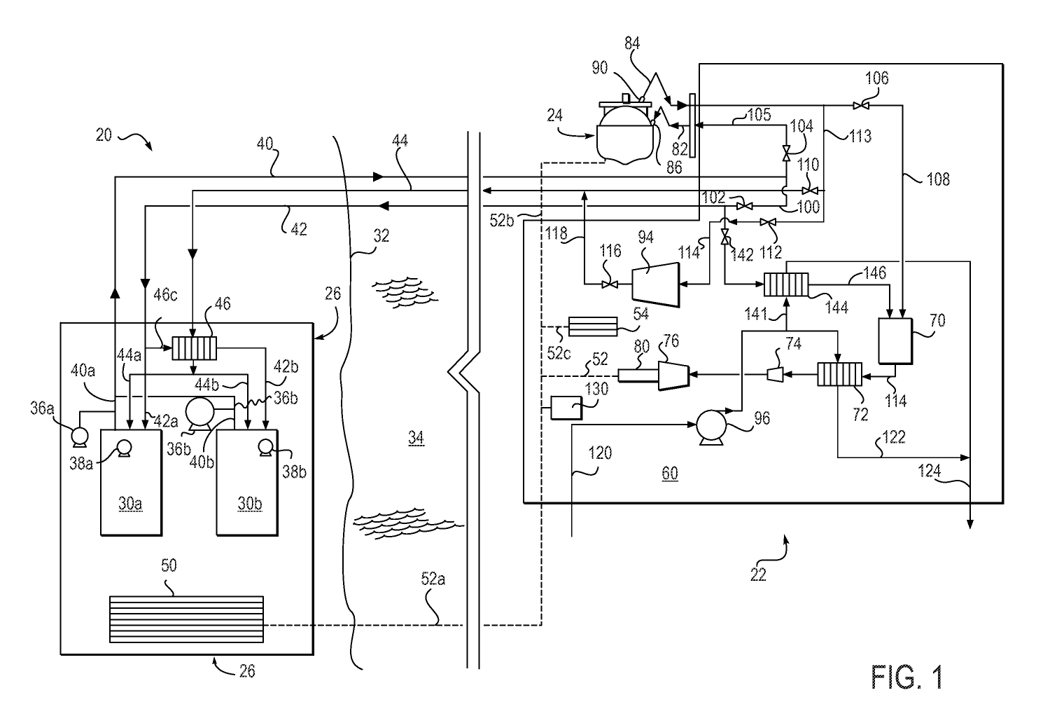

In the particular first embodiment schematically shown in FIG. 1, onshore LNG facility 26 is a liquefaction plant where natural gas is converted to liquefied natural gas (LNG) which is stored in LNG storage tanks 30a and 30b. While two tanks are shown, it will be appreciated one or more LNG tanks can actually be used in practice. Ideally, LNG facility 26 is located near a shoreline 32 of a body of water or sea 34. Large and powerful LNG primary pumps 36a, 36b provide energy to move LNG from tanks 30a and 30b to offshore marine terminal 22. Similarly, smaller recirculation LNG pumps 38a, 38b may be disposed within LNG tanks 30a and 30b to pump LNG from tanks 30a and 30b as well.

Main LNG conduit 40 and auxiliary LNG conduit (cool down line) 42, transfer LNG between onshore facility 26 and offshore marine terminal 22. LNG primary pumps 36a and 36b provides energy to move LNG through tank conduits 40a and 40b and into main LNG transfer conduit 40 and out to LNG carrier 22. Meanwhile, recirculating LNG pumps 38a, 38b are turned off in this LNG loading mode of LNG carrier 22. LNG is allowed to return back to tanks 30a and 30b through auxiliary LNG transfer conduit 42 and a pair of tank conduits 42a and 42b. The arrows in FIG. 1 indicate the direction of flow of LNG through conduits 40 and 42 during loading of LNG on to an LNG carrier 24. That is, LNG flows out from LNG tanks 30a and 30b to LNG carrier 24 through main LNG transfer conduit 40. Meanwhile, a small portion of LNG is returned to LNG tanks 30a and 30b through auxiliary LNG transfer conduit 42 and tank conduits 42a and 42b.

A main BOG transfer conduit 44 (vapor line) allows BOG to be transferred between LNG facility 26 and offshore marine terminal 22. A cooler 46 at LNG facility 26 cools BOG returning from offshore marine terminal 22 by way of main BOG transfer conduit 42 with BOG cooler conduits 44a and 44b delivering BOG to tanks 30a and 30b, respectively. The BOG reaching tanks 30a and 30b will be reliquefied due to the large heat capacity of the LNG in tanks 30a and 30b. Cooler 46 receives LNG tapped off of auxiliary LNG transfer conduit 42 by way of cooler conduit 46c to cool down BOG passing through cooler 46 prior to the cooled BOG being reintroduced into LNG tanks 30a and 30b by way of cooler conduits 44a and 44b.

An onshore electrical power grid 50 is available to receive electricity generated at offshore marine terminal 22 and transferred by an electrical conduit 52a from offshore marine terminal 22. Electrical power delivered to onshore power grid 50 may be used by LNG facility 26 or passed on to other onshore power grids (not shown) or users of electrical power.

The main LNG transfer conduit 40 and auxiliary transfer conduit 42 have differing purposes. The primary purpose of main LNG transfer conduit 40 is to transfer LNG with as little flow resistance as possible while minimizing heat absorption by LNG flowing there through. Main LNG transfer conduit 40 is therefore much larger in size than auxiliary LNG transfer conduit 42. By way of example and not limitation, main LNG transfer conduit 40 may be about 30-42 inches in diameter while auxiliary LNG transfer conduit 42 is on the order of about 4-6 inches in diameter. With the larger size or diameter, main LNG transfer conduit 40 offers much less resistance to LNG flow than does the much smaller auxiliary LNG transfer conduit 42. Ideally, LNG is constantly kept flowing within main LNG transfer conduit 40 and auxiliary LNG transfer conduit 42 to maintain low temperature and to avoid thermal stresses induced by fluctuating temperatures in conduits 40 and 42.

Auxiliary LNG transfer conduit 42 serves as a cool down line supplying LNG to cooler 46. When LNG is being transferred between main LNG transfer conduit 40 and LNG carrier 24, i.e. cargo loading time, LNG auxiliary conduit 42 receives LNG from main LNG transfer conduit onboard or proximate offshore marine terminal 22 and routes a small portion of LNG back to onshore LNG facility 26. A portion of the LNG flowing through auxiliary LNG transfer conduit 42 is tapped off and passes through cooler 46 and cools BOG arriving from BOG transfer conduit 44 prior to the BOG being transferred into LNG storage tanks 30a and 30b.

Offshore LNG marine terminal 22 includes a platform 60 on which equipment is mounted. In this embodiment, platform 60 which is mounted on vertically extending legs (fixed leg platform—not shown) anchored to the sea floor. Alternatively, platform 60 maybe a part of a jetty extending from onshore LNG facility 26 out to marine terminal 22. If a jetty is used, main and auxiliary LNG transfer conduits 40 and 42, main BOG transfer conduit 44, and electrical conduit 52a, are preferably mounted upon the jetty for ease of access and maintenance. Without the use of the jetty, main and auxiliary LNG transfer conduits 40 and 42, BOG conduit 44, and electrical conduit 52a will reside upon the sea floor until reaching platform 60. As another non-limiting example, platform 60 may be a floating platform (not shown) tethered and anchored to the sea floor.

Among the pieces of equipment, which are supported on platform 60 in this first exemplary embodiment, are a BOG storage tank 70, a BOG heater 72, a gas compressor 74, a combustor 76, an electrical generator 80 and an output electrical conduit 52. Also, mounted on platform 60 are an LNG loading conduit 82 and a BOG receiving conduit 84 which are designed to releasably connect with manifolds 86 and 90 on LNG carrier 24, respectively. Ideally, conduits 82 and 84 are conventional loading arms used to transfer fluids to and from LNG carriers relative to terminals. Also, located on platform 60 are a BOG booster compressor 94 and a seawater pump 96.

LNG pumped through main LNG transfer conduit 40 is placed in fluid communication with auxiliary LNG transfer conduit 42 by way of a control valve 102 in an LNG transfer conduit 100. Valve 102 is opened to allow LNG from main LNG transfer conduit 40 to partially flow into auxiliary LNG transfer conduit 42 with the remainder of LNG being passed to LNG loading conduit 82. A valve 104 in an LNG conduit 105, which connects to LNG loading conduit 82, allows LNG to reach LNG carrier 24.

As a result of resistance to flow and energy input, as well as heat transfer to the LNG along the transfer through main LNG transfer conduit 40, LNG conduit 105 and loading conduit 82 and differential pressure between the LNG in these conduits and within the LNG carrier storage tanks, large quantities of BOG gas will be generated in the LNG carrier's storage tanks. The BOG is captured from the LNG storage tanks and is then routed to be discharged at BOG manifold 90 of LNG carrier 24. As is well known to those skilled in the art of LNG carriers, such systems for capturing and transporting BOG from LNG carriers are quite conventional. Gas compressors (not shown) already onboard LNG carrier 24 are used to propel the BOG from the onboard LNG storage tanks to BOG manifold 90.

BOG receiving conduit 84 is releasably connected to BOG manifold 90 and at least a portion of the BOG is transferred to a BOG conduit 108 and stored in BOG storage tank 70 on platform 60. Control valve 106 in BOG conduit 108, control valve 110 in main BOG transfer conduit 44 and control valve 112 in BOG conduit 114 may be used to direct the BOG into the BOG storage tank 70 or to main BOG return conduit 44 or to BOG conduit 114 and booster compressor 94 or else to shut off the flow of BOG through loading conduit 84. In this LNG loading mode, valve 110 is closed so that the BOG must pass through conduit 114 which is connected to booster compressor 94 so that BOG, which is not stored in storage tank 70 and combusted, can be routed under pressure to LNG facility 26 through BOG return conduit 44. A valve 116 is opened in a BOG conduit 118 to allow BOG to flow between compressor 94 and main BOG transfer conduit 44.

Large amounts of BOG are created when LNG is first filling the storage tanks of LNG carrier 24 such that all of the BOG may not be able to be either stored in LNG tank 70 or combusted by BOG combustor 74. Accordingly, BOG return conduit 44 provides an outlet for disposal of excess BOG not capable of being combusted. However, as a significant portion of BOG is combusted, the size of return BOG conduit 44 can be made smaller and the cost of installing BOG conduit 44 can be reduced as compared to a system where all of the BOG must be transferred onshore and none of the BOG is combusted. Further, booster compressor 94 can also be sized to require much less horsepower as less BOG must be transported back to LNG facility 26 due to the combustion of some of the BOG in combustor 76 and the generation of electricity.

BOG stored in storage tank 70 is then routed by BOG conduit 114 to BOG heater 72 for heating prior to being sent to combustor 76. Seawater pump 96 draws seawater in through a seawater inlet conduit 120 to provide heat to BOG heater 72, which is a heat exchanger such as a plate and fin heat exchanger. Chilled seawater exiting from heater 72 can then be disposed of through seawater outlet conduits 122 and 124. Gas compressor 74 is used to increase the pressure of the BOG before reaching combustor 76 to meet the input pressure requirements of combustor 76. BOG is combusted in combustor 76 creating power to drive electrical generator 80 with electricity being output through electrical conduit 52. In this preferred embodiment, combustor 76 and electrical generator 80 are an integrated gas turbine generator. Alternatively, a diesel engine, capable of combusting BOG, may be used to power a conventional electrical generator. Those skilled in the art will appreciate that other combustor/electrical generators may also be used as well to generate electricity.

Electricity generated onboard offshore marine terminal 22 can be directed to a number of electrical consumers. For example, excess electricity can be sent by way of electrical conduit 52a onshore to power grid 50. Also, electricity can be transmitted by way of electrical conduits 52b to LNG carrier 24. If sufficient electricity is sent to LNG carrier 24, then LNG carrier 24 can be at least partially “cold ironed”. That is, combustors driving electrical generators on LNG carrier 24 can be shut down thereby minimizing emissions from those combustors. Another potential use of generated electricity is to pass electricity through conduits 52c to an electrical grid 54 on offshore marine terminal 22 that can power one or more of BOG booster compressor 94 or seawater pump 96 or other onboard electrical equipment. Moreover, electricity can be provided to other floating or offshore consumers of electrical power apart from offshore LNG marine terminal 22. Further, a portion of the generated electricity could be stored as energy in battery banks 130 in the event that combustor 76 is shut down or an additional supply of electricity is needed to augment that electricity currently being produced by generator 80.

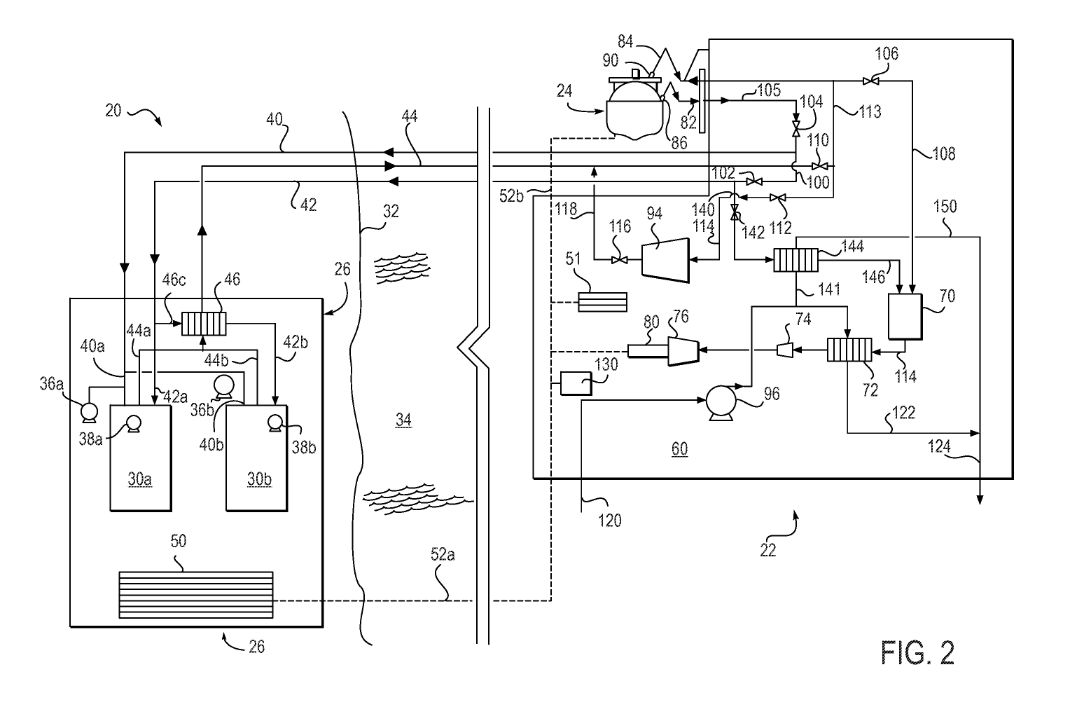

FIG. 2 is similar to FIG. 1 with the similar components being identified by the same reference numerals. However, in this embodiment, an LNG carrier 24 is being unloaded rather than being loaded with an LNG cargo. LNG is discharged from manifold 86 of LNG carrier 24 into an offloading LNG conduit 82. LNG conduit 82 is in fluid communication with main LNG transfer conduit 40. Cargo pumps aboard LNG carrier 24 are used to provide the energy needed to transport LNG through main LNG conduit 40 and to onshore facility 22. LNG is stored in LNG storage tanks 30a and 30b. Also, a portion of the unloaded LNG is introduced to LNG conduit 100 and then passed to auxiliary LNG transfer conduit 42 to cooler 46. Cooler 46 cools outbound BOG from onshore LNG storage tanks 30a and 30b. The heated LNG received from cooler 46 is then delivered to and mixed in LNG tanks 30a and 30b.

With LNG being removed from storage tanks on LNG carrier 24, BOG must be added to these tanks to avoid a vacuum being formed in the tanks. BOG from LNG storage tanks 30a and 30b are propelled by recirculation BOG compressors located in LNG storage tanks 30a and 30b to onshore cooler 46 for cooling. The BOG is then delivered from cooler 46 to main BOG transfer conduit 44 and valve 110. Valve 110 is opened permitting BOG in BOG conduit 113 to reach BOG loading conduit 84 which is releasably attached to manifold 90 of LNG carrier 24. BOG is passed into LNG carrier 24 LNG storage tanks. After pressure requirements in the LNG tanks of LNG carrier 24 are met, excess BOG is routed to conduit 108 and stored in BOG storage tank 70 of offshore marine terminal 22. Again, BOG is heated in heater 72, compressed by compressor 74 and combusted in combustor 76. Combustor 76 drives electrical generator 80 producing electricity such as may be used to power seawater pump 96 or transferred on shore power grid 50 or transferred to LNG carrier 24 or otherwise consumed on offshore terminal 22. Seawater pump 96 sends seawater to heater 74 to provide heat with chilled seawater being disposed by outlet seawater conduit 122 and 124.

In the event that BOG in the offshore BOG storage tank 70 becomes so depleted that insufficient BOG can be provided to electrical generator 80 to provide a desired output of electricity, BOG can be added to BOG storage tank other than from LNG tanks on LNG carrier 24. A portion of the LNG may be withdrawn from one or both of main or auxiliary LNG conduits 40 and 42. For example, as shown in FIG. 2, an LNG transfer conduit 140 can receive LNG through a valve 142 from auxiliary LNG conduit 42. The withdrawn LNG is then vaporized by a vaporizer 144 into BOG. This supplemental BOG can then sent back to LNG storage tank 70 by way of BOG transfer conduit 146. Seawater from seawater pump 96 and seawater conduit 120 are provided to sea water conduit 141 to vaporizer 144 to provide heat. The chilled seawater exiting from vaporizer 144 is then returned to the sea using outlet conduits 150 and 124.

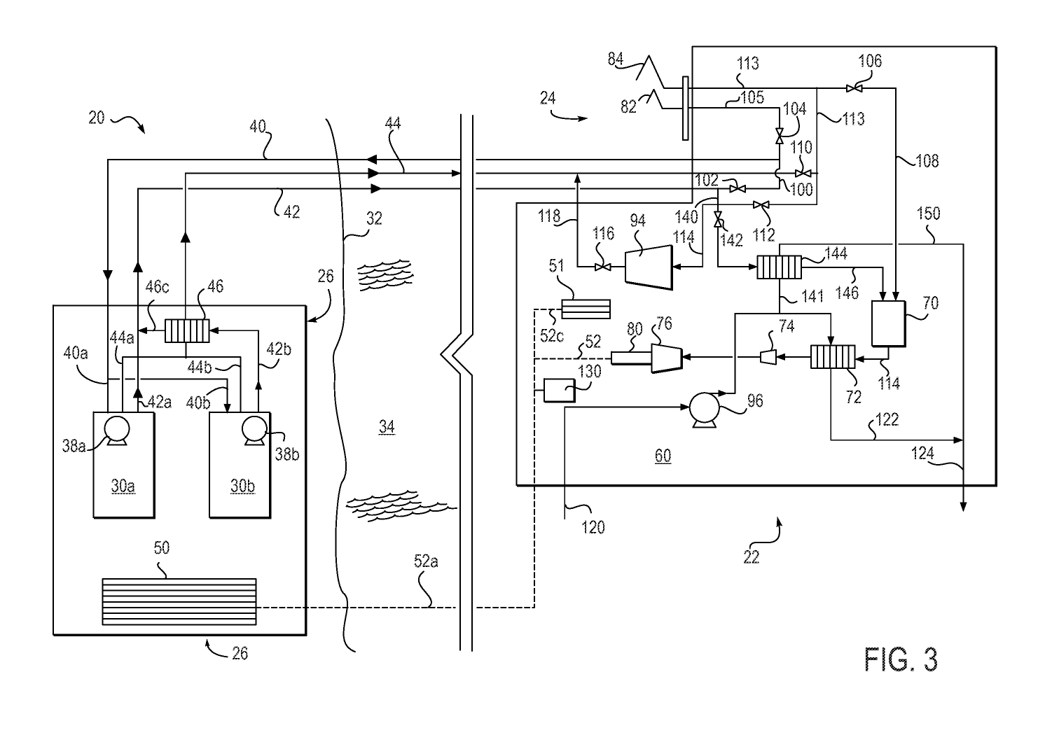

Referring now to FIG. 3, system 20 is shown in an “idle” state where no LNG carrier is present and no LNG is transferred to or from an LNG carrier. Auxiliary LNG transfer conduit 42 can be used as a recirculating line to cool main LNG transfer conduit 44 when LNG is not be transferred to or from LNG carrier 24. LNG is pumped from storage tanks 30a and 30b by way of small recirculating LNG pumps 38a, 38b and through auxiliary LNG transfer conduit 42. Valve 104 is closed preventing LNG from passing to LNG loading conduit 82. Valve 102 can be opened to allow LNG to pass to LNG transfer conduit 100 and recirculate back by way of main LNG transfer conduit 40 to LNG storage tanks 30a and 30b. Ideally, main and auxiliary LNG conduits 40 and 42 will remain filled with LNG and only slowly circulated to maintain cold in these conduits. In this manner, both main and auxiliary LNG transfer conduits 40 and 42 are kept cold and fatigue in conduits 40 and 42 is minimized due thermal stresses induced by fluctuating temperatures.

As discussed above with FIG. 2, LNG can also be tapped off of auxiliary LNG transfer conduit 42, routed to vaporizer 144 with BOG be sent by conduit 146 to BOG storage tank 70. BOG from BOG storage tank 70 can again be heated, compressed and combusted with electricity being generated by generator 80.

### EXAMPLE 1

Cost savings using the above system 20, as compared to sending all of the BOG through a main BOG transfer conduit 44 to shore is significant. A smaller BOG return line of 9-16 inches versus 48 inches at about 20 kilometers length might be used, as a non-limiting example. Also, a smaller booster compressor 94 can be used transfer BOG to onshore LNG facility 26 as compared to a booster compressor needed to transfer all of BOG to shore, when system 20 is in an LNG loading mode on to LNG carrier 24. Additionally, the transmission of generated electricity is quite a bit more economic than the fluid transport of BOG.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. For example, the equipment of offshore marine terminal 22 could disposed on one or more platforms adjacent to where LNG carriers berth. Or else, some of the equipment or conduits may not be placed on a platform. In any event, the collective equipment shall still be understood to be, collectively, an offshore marine terminal which is capable of storing BOG, combusting the BOG and generating electricity while reducing the amount BOG which must circulated.

What is claimed is:

1. An offshore marine terminal comprising:
a.) a platform anchored relative to a sea floor;
b.) a BOG storage tank for storing BOG and supported by the platform;
c.) a combustor, in fluid communication with the offshore storage tank to receive BOG there from and for combusting BOG; and
d.) an electrical generator for generating electricity which is powered by the combustor
Wherein the offshore marine terminal is located distant from an onshore LNG facility

2. The offshore marine terminal further comprising:
at least one electrical conduit for transferring electricity between the offshore terminal and an onshore site.

3. The offshore marine terminal of claim 1 further comprising:
a BOG conduit adapted for receiving BOG from an LNG carrier and transferring the BOG to the BOG storage tank.

4. The offshore marine terminal system of claim 1 further comprising:
a pump receiving power from the electrical generator which is used to pump LNG.

5. The offshore marine terminal of claim 1 further comprising:
a vaporizer to vaporize LNG, the vaporizer being in fluid communication with the offshore BOG storage tank to supply BOG to the BOG storage tank.

6. The offshore marine terminal of claim 1 wherein:
the platform is one of a jetty extending to onshore and a fixed platform supported upon legs anchored to the sea floor, and a floating structure anchored relative to the sea floor.

7. A system for combusting boil-off gas and generating electricity at an offshore LNG marine terminal, the system comprising:
a) an onshore LNG facility including at least one LNG storage tank;
b) an offshore marine terminal comprising:
i.) a platform anchored relative to a sea floor;
ii.) a BOG storage tank for storing BOG and supported by the platform;
iii.) a combustor, in fluid communication with the offshore BOG storage tank to receive BOG there from and for combusting BOG; and
iv.) an electrical generator for generating electricity which is powered by the combustor; and
c) a transfer conduit system comprising:
i.) a main LNG transfer conduit transferring LNG between the onshore LNG facility and the offshore marine LNG terminal;
ii.) an auxiliary LNG transfer conduit transferring LNG between the onshore LNG facility and the offshore marine LNG terminal; and
iii.) a main BOG transfer conduit for transferring BOG between the onshore LNG facility and the offshore marine LNG terminal.

8. The system of claim 7 wherein:
the BOG storage tank of the offshore LNG marine terminal is adapted to receive BOG from an LNG carrier berthed at the offshore LNG marine terminal.

9. A method for combusting BOG and generating electricity at an offshore marine terminal, the method comprising:
a) receiving and storing BOG in an offshore BOG storage tank of an offshore marine terminal;
b) combusting BOG received from the offshore BOG storage tank and generating electricity at the offshore marine terminal; and
c) transmitting the generated electricity.

10. The method of claim 9 wherein:
the electricity is transmitted to at least one of an onshore facility and electrically powered equipment of the offshore marine terminal and a LNG carrier and electrically powered equipment disposed offshore.

11. The method of claim 10 wherein:
the electricity is transmitted to an onshore facility from the offshore marine terminal.

12. The method of claim 9 wherein:
the electricity is transmitted to an LNG carrier; and
at least one combustor and at least one generator on the LNG carrier is shut down to reduce emissions from the operation of the LNG carrier.

13. The method of claim 9 wherein:
the offshore marine terminal is at least two kilometers from an onshore LNG facility.

14. The method of claim 9 wherein:
at least a portion of the received BOG is collected from at least one storage tank on an LNG carrier.

15. The method of claim 9 wherein:
at least a portion of the received BOG is generated using an LNG vaporizer of the offshore marine terminal.

16. The method of claim 15 wherein:
the LNG vaporizer is used to generate BOG when an LNG carrier is not berthed at the offshore marine terminal.

17. The method of claim 9 wherein:
the generated electricity is used to power at least one gas compressor to blow BOG back to the onshore LNG facility.

18. The method of claim 9 wherein:
the offshore marine terminal includes a support supporting the at least one BOG storage tank, the support being one of a jetty extending to shore and a fixed platform supported upon a sea floor, and a floating structure anchored relative to the sea floor.

19. A method for utilizing offshore boil-off gas (BOG) stored in an offshore BOG storage tank, the method comprising:
capturing BOG from at least one of an LNG carrier and an LNG conduit transferring LNG from an onshore LNG facility;
storing the captured BOG in a gas storage tank disposed on an offshore marine terminal;
transferring boil-off gas from the offshore storage tank to an offshore combustor and electrical generator to combust the BOG and generate electricity; and
transferring the electricity generated by the offshore electrical generator to an onshore power grid.
